(19) United States
(12) Patent Application Publication
(10) Pub. No.: US 2017/0255655 A1
(43) Pub. Date: Sep. 7, 2017

(54) BUILDING DIMENSIONAL HIERARCHIES FROM FLAT DEFINITIONS AND PRE-EXISTING STRUCTURES

(71) Applicant: OpenGov, Inc., Redwood City, CA (US)

(72) Inventor: Matthew SEAL, Sunnyvale, CA (US)

(21) Appl. No.: 15/063,118

(22) Filed: Mar. 7, 2016

(51) Int. Cl. G06F 17/30

(52) U.S. Cl. CPC G06F 17/30292; G06F 17/30687

(57) ABSTRACT

Techniques are disclosed for generating an organized hierarchy from a set of related data. A request is received to generate an organized hierarchy from a data set. The data set includes labels and contextual cues associated with each of the of labels. For each label, one or more candidate labels are identified based on a probabilistic model generated from a plurality of known ontological hierarchies. The label is matched and assigned to one of the candidate labels. Hierarchy paths associated with the assigned candidate labels are joined with one another to build the organized hierarchy.

### BACKGROUND

Field

Embodiments presented herein generally relate to techniques for natural language processing. More specifically, techniques are disclosed for generating an organized hierarchy from a set of related data.

Description of the Related Art

Open data, the concept of making certain data freely available to the public, is of growing importance. For example, demand for government transparency is increasing, and in response, governmental entities release a variety of data to the public. One example relates to financial transparency, where city governments make budgets and other finances available to the public. This allows for more effective public oversight. For instance, a user can analyze the budget of a city to determine how much the city is spending for particular departments and programs. In addition, the user can compare budgetary data between different cities to determine, e.g., how much other cities are spending on respective departments. This latter example is particularly useful for a department head at one city who wants to compare spending, revenue, or budgets with comparable departments in other cities.

Financial and budgetary data for a given governmental entity is typically voluminous, which creates the need for data to be presentable to the user, such that the user can meaningfully analyze the data. To this effect, governmental entities use a chart of accounts to present financial data in an organized fashion. As known, a chart of accounts is a densely structured document that provides identifiable terminology and clearly defines hierarchies within a given city. A user may reference a chart of accounts to identify, e.g., budgetary and spending data of various departments.

In some cases, a chart of accounts for a given entity might not be readily available. This presents difficulty for individuals to analyze budgetary data of a city. However, individuals may analyze other documents to analyze budgetary data, such as a general ledger. As known, a general ledger is a complete record of financial transactions of an entity, and is typically more available. The general ledger is flat in nature and includes a limited amount of information, such as a date of the transaction, amount, and an account string indicating, e.g., a group associated with the transaction, whether the transaction is a positive or negative debit or credit, etc. However, because the information provided by a general ledger is typically limited and sometimes difficult to decipher, using the general ledger to analyze financial and budgetary data may present some challenges to an individual.

### SUMMARY

One embodiment presented herein discloses a method for generating an organized hierarchy from an input data set based on related data. This method generally includes receiving a request to generate an organized hierarchy from a data set. The data set includes a plurality of labels and contextual cues associated with each of the plurality of labels. For each label, one or more candidate labels potentially matching to the label are identified based on a probabilistic model generated from a plurality of known ontological hierarchies. Each of the candidate labels is associated with a given hierarchy path. Further, the label is matched to one of the candidate labels based on the probabilistic model and assigned to the matched candidate label. The hierarchy paths associated with the assigned candidate labels are joined with one another to build the organized hierarchy.

Another embodiment presented herein discloses a non-transitory computer-readable storage medium storing instructions, which, when executed on a processor, performs an operation for generating an organized hierarchy from an input data set based on related data. The operation itself generally includes receiving a request to generate an organized hierarchy from a data set. The data set includes a plurality of labels and contextual cues associated with each of the plurality of labels. For each label, one or more candidate labels potentially matching to the label are identified based on a probabilistic model generated from a plurality of known ontological hierarchies. Each of the candidate labels is associated with a given hierarchy path. Further, the label is matched to one of the candidate labels based on the probabilistic model and assigned to the matched candidate label. The hierarchy paths associated with the assigned candidate labels are joined with one another to build the organized hierarchy.

Yet another embodiment presented herein discloses a system having a processor and a memory. The memory hosts an application, which, when executed on the processor, performs an operation for generating an organized hierarchy from an input data set based on related data. The operation itself generally includes receiving a request to generate an organized hierarchy from a data set. The data set includes a plurality of labels and contextual cues associated with each of the plurality of labels. For each label, one or more candidate labels potentially matching to the label are identified based on a probabilistic model generated from a plurality of known ontological hierarchies. Each of the candidate labels is associated with a given hierarchy path. Further, the label is matched to one of the candidate labels based on the probabilistic model and assigned to the matched candidate label. The hierarchy paths associated with the assigned candidate labels are joined with one another to build the organized hierarchy.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

Note, however, that the appended drawings illustrate only typical embodiments of this invention and are therefore not to be considered limiting of its scope, for the invention may admit to other equally effective embodiments.

FIG. 1 illustrates an example computing environment, according to one embodiment.

FIG. 2 illustrates an example abstraction of an account string relative to a corresponding hierarchical structure, according to one embodiment.

FIG. 3 further illustrates the chart of accounts generation tool described relative to FIG. 1, according to one embodiment.

FIG. 4 illustrates an example data flow of generating a chart of accounts from a general ledger, according to one embodiment.

FIG. 5 illustrates a method for generating an organized hierarchy from a set of data, according to one embodiment.

FIG. 6 illustrates a method for identifying a hierarchical label corresponding to a general ledger entry, according to one embodiment.

FIG. 7 illustrates an example evaluation of a ledger label and code segment against candidate labels, according to one embodiment.

FIG. 8 illustrates an example server computing system configured to generate an organized hierarchy from a set of data, according to one embodiment.

### DETAILED DESCRIPTION

Embodiments presented herein provide techniques for generating an organized hierarchy from a set of related data. For example, the techniques provided may be adapted in a financial transparency application to derive a chart of accounts from a general ledger of an organization (e.g., a city government) using related data, such as existing charts of accounts of other organizations.

As stated, a general ledger is a complete record of financial transactions of an entity, and is typically more available. The general ledger is typically rigid in that each entry contains a limited amount of data, such as a date of a transaction, amount of the transaction, and an account string associated with the transaction. However, certain contextual information can be inferred from each entry. For example, general ledgers may also include descriptions that may provide contextual cues indicating where in a hierarchy of a chart of accounts that a given entry may belong. And further, charts of accounts from other entities tend to share similar hierarchical structures with one another. For example, a chart of accounts of city A and a chart of accounts of city B may be organized by fund type, such as “Taxes,” and each chart of accounts may include a “General Property Taxes” account under “Taxes.”

In one embodiment, the financial transparency application builds a chart of accounts from an input general ledger from reference charts of accounts, contextual information associated with the general ledger, and an ontological structure of semantically-related data sets. More specifically, for each row entry of the general ledger, financial transparency application identifies matches the entry against possible candidates for a corresponding entry in the resulting chart of accounts based on a probabilistic model. The probabilistic model indicates a likelihood that a given hierarchy path of a candidate is a match for the entry.

Further, the financial transparency application determines, using the probabilistic model, a confidence of each match based on the likelihood that the entry actually (or relatively closely) corresponds to the candidate. If a given match having the highest confidence score is a good match (e.g., exceeds a specified threshold), the financial transparency application extracts a path from the hierarchy that the candidate belongs to. The financial transparency application then maps the account string of the entry to the hierarchy path. In the event that the financial transparency application is unable to initially identify matches of a high confidence, the financial transparency application may evaluate additional cues from the general ledger, such as neighboring rows that were successfully mapped to a hierarchy tree of the resulting chart of accounts.

The resulting chart of accounts represents an organized hierarchy of the account codes specified in the rows of the general ledger. The financial transparency application may return the chart of accounts to an administrator to review. The administrator may edit the chart of accounts as needed (e.g., for entries matched to candidates with relatively low confidence scores).

The following description relies on a financial transparency software application as a reference example for generating an organized hierarchy from a set of data using a probabilistic model built from related data. However, one of skill in the art will recognize that embodiments are applicable in other contexts related to determining hierarchical information from a flat set of data. For example, embodiments may be used in an application to identify departmental hierarchies of an organization that are not immediately available based on pre-existing departmental information associated with the organization.

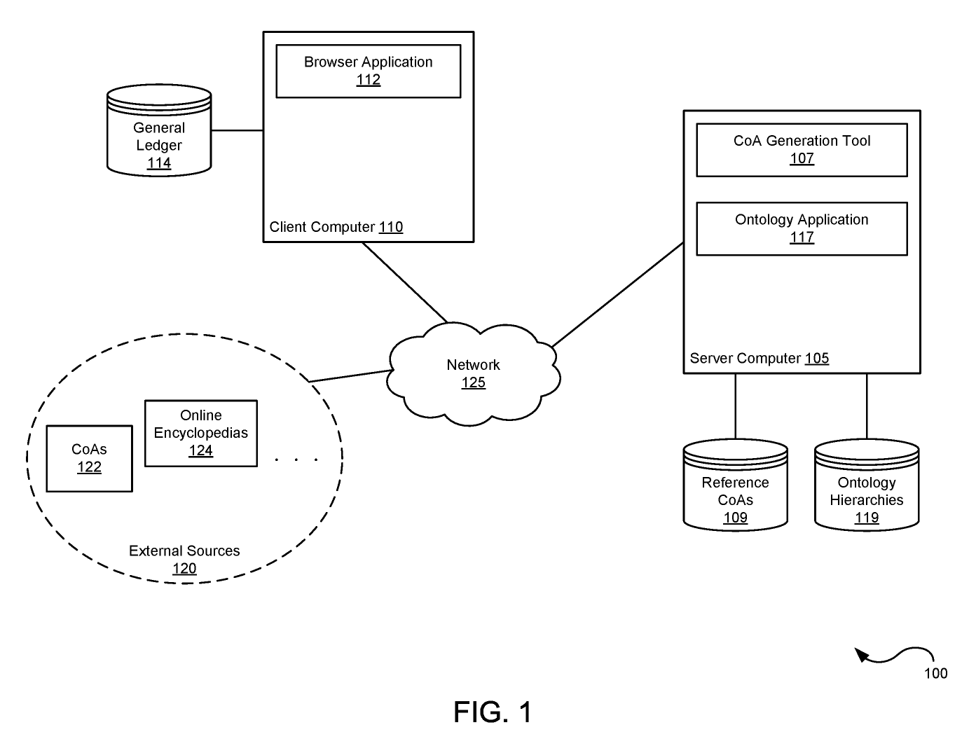

FIG. 1 illustrates an example computing environment 100, according to one embodiment. As shown, the computing environment 100 includes a server computer 105, a client computer 110, and external sources 120, each connected via a network 125. The server computer 105 may be a physical computing system (e.g., a system in a data center) or a virtual computing instance executing within a computing cloud. In one embodiment, the server computer 105 hosts a chart of accounts (CoA) generation tool 107 and an ontology application 117. The CoA generation tool 107 and the ontology application 117 may collectively be a part of a financial transparency application that allows a user (e.g., an administrator, city planner, citizen, etc.) to browse budgetary data of different state and local governments in the form of a chart of accounts. The chart of accounts provides a set of acyclic hierarchical labeled graphs representing dimensions of data relative to other data records.

For example, the user may, via a browser application 112 executing on the client computer 110, view and compare budgetary data between two city governments. Because data sets between different cities may be dissimilar in labeling and hierarchical structures (e.g., a “Sewage Processing” department in city A may have a corresponding “Water Treatment” department in city B), the ontology application 117 builds ontology hierarchies 119 based on natural language processing (NLP) techniques from external sources 120 (e.g., existing CoAs 122 and online encyclopedias 124). In one embodiment, the ontology hierarchies 119 provide a normalized tree hierarchy of entity clusters, where each cluster is associated with one or more elements observed in the external sources 120, known as “mentions.” Mentions are contextualized references (e.g., often represented as nouns or noun phrases) to a given entity cluster. In practice, the ontology hierarchies 119 may include thousands of references to charts of accounts of various organizational entities that have been evaluated by the ontology application 117, where each cluster includes account codes for each mention contained within the cluster. For example, a given cluster of elements may group mentions such as “Local Sales Tax,” “L. Sales,” and “L.S.->Taxes.” In this example, such mentions may logically relate to a concept of a Local Sales Tax account, grouped together using an NLP algorithm, such as one used to determine a Levenshtein distance.

In some cases, an individual (e.g., an administrator in a financial department of a governmental entity) may want to construct a chart of accounts for a given governmental entity. In one embodiment, the CoA generation tool 107 takes, as input, a general ledger 114 (e.g., uploaded to the server computer 105) as part of a request to build a chart of accounts from the general ledger. As known, a general ledger is a two-dimensional document having rows and columns, where each row is a ledger entry having column data that describe a particular transaction of an organization. Column data may include information such as a date, monetary amount, and an account string. The account string may reference a position in a hierarchical structure indicating where in the structure the transaction belongs.

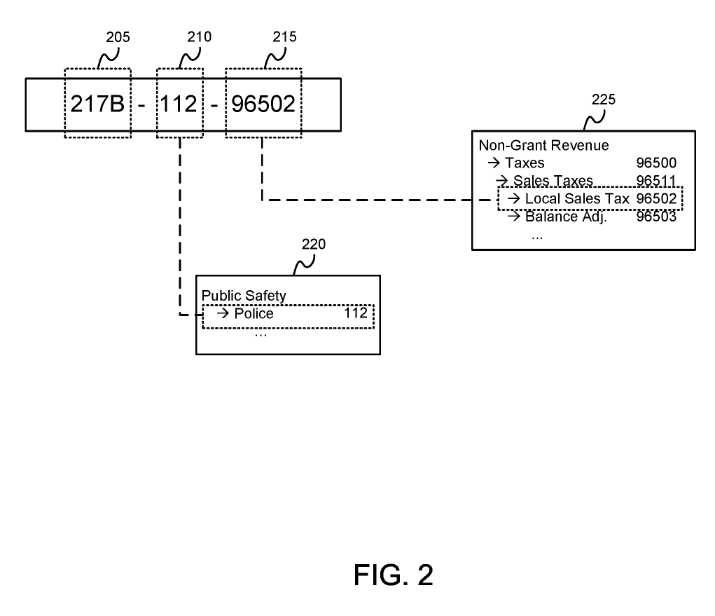

For example, FIG. 2 illustrates an example abstraction of a general ledger account string as it relates to corresponding hierarchical structures, according to one embodiment. Particularly, components of an account string may be expressed as elements of an acyclic organized hierarchy, for the purposes of generating a CoA from a general ledger. Rows in the general ledger are associated with leaf nodes (terminating elements) in the hierarchy.

Illustratively, the account string includes three components 205, 210, and 215. Of course, an actual account string may include a variety of additional components representing different column data. The component 205 “217B” may represent a fund reference code, i.e., a source of money for the transaction. For example, the component 205 might indicate that the underlying transaction may be related to a General Funds account.

The component 210 may represent a department code, i.e., a department within the organizational entity that was responsible for the transaction. As shown, the component 210 “112” is associated with “Police” in a hierarchy tree 220 that includes a number of leaf nodes. Illustratively, “Police” is a leaf node to “Public Safety” in the hierarchy tree 200.

The component 215 may represent a ledger group associated with the transaction. For example, the transaction may correspond to a revenue transaction received from local sales taxes. Illustratively, the component 215 “96502” is associated with a hierarchy tree 300. The hierarchy tree 300 specifies that component 215 “96502” corresponds to a “Local Sales Tax” label. Illustratively, the “Local Sales Tax” is a leaf nested under “Non-Grant Revenue”->“Taxes”->“Sales Taxes.” Non-leaf nodes in the hierarchy tree 300 may be metadata describing the leaf. In this example, “Local Sales Tax” represents a type of non-grant revenue, tax, and sale tax.

As demonstrated, entries of the general ledger may be expressed in hierarchical forms. The CoA generation tool 107 may generate an output chart of accounts from the general ledger based on given contextual cues from the general ledger and known data (e.g., the reference CoAs 109 and ontology hierarchies 119). To do so, the CoA generation tool 107 matches labels of each general ledger row to contextually associated hierarchies. As further described, the CoA generation tool 107 uses probabilistic associations of visible and suggested context elements—entering semi-known identifier contexts and known context into a probabilistic association algorithm.

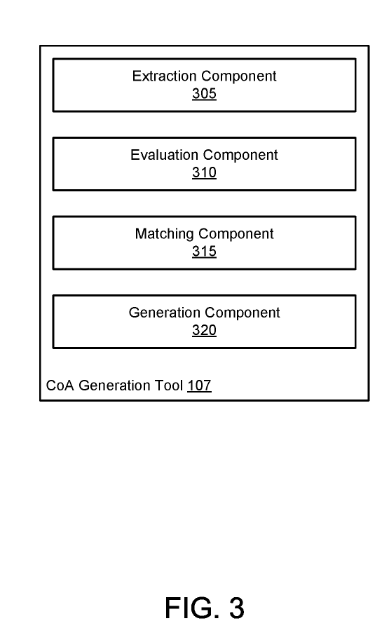

FIG. 3 further illustrates the CoA generation tool 107, according to one embodiment. As shown, the CoA generation tool 107 includes an extraction component 305, an evaluation component 310, a matching component 315, and a generation component 320.

In one embodiment, the extraction component 305 receives a request from a user to generate a chart of accounts from a general ledger provided as input with the request. The extraction component 305 retrieves row entry and column data for further processing by other components of the CoA generation tool 107. In particular, the extraction component 305 retrieves an account string that may include labels and account codes to be associated with a position in a resulting chart of accounts hierarchy.

In one embodiment, the evaluation component 310 identifies, in the column data for a given entry and in neighboring rows of the general ledger, contextual cues and other probabilistic indicators that can be used in matching a row entry label to a corresponding candidate in a reference CoA 109 or ontology hierarchies 119. Further, the evaluation component 310 may identify candidate account strings and labels in reference CoAs 109 and ontology hierarchies 119 that are similar to a given row entry of the general ledger.

Using the account string “217B-112-96502” example described relative to FIG. 2, the evaluation component 310 may identify other account strings with similar components such as “96501” or “96500” in the ontology hierarchy 119 that have labels referring to other categories of taxes, such as sales taxes or other types. Doing so allows the evaluation component 310 to build a probabilistic model (e.g., a Markov chain, naive Bayes classifiers, etc.) that indicates the confidence scores for each of the identified candidates. The model may be generated from a union space of the candidates.

In one embodiment, the matching component 315 identifies, using the probabilistic model, matches between a row entry label to a candidate label. The matching component 315 may determine whether a match having a highest confidence score between the candidate labels exceeds a specified threshold (indicating a “good” match). In addition, the matching component 315 may also use additional contextual cues to identify further matches (or reinforce confidence scores) in the event that none of the current matching candidates exceeds the threshold. The matching component 315 may extract hierarchy paths associated with a candidate label that is a good match.

In one embodiment, the generation component 320 builds a chart of accounts by joining the hierarchy trees of identified matches having a relatively high confidence score. The generation component 320 may output the resulting chart of accounts to the user. The user may then review the chart of accounts and edit the assigned labels.

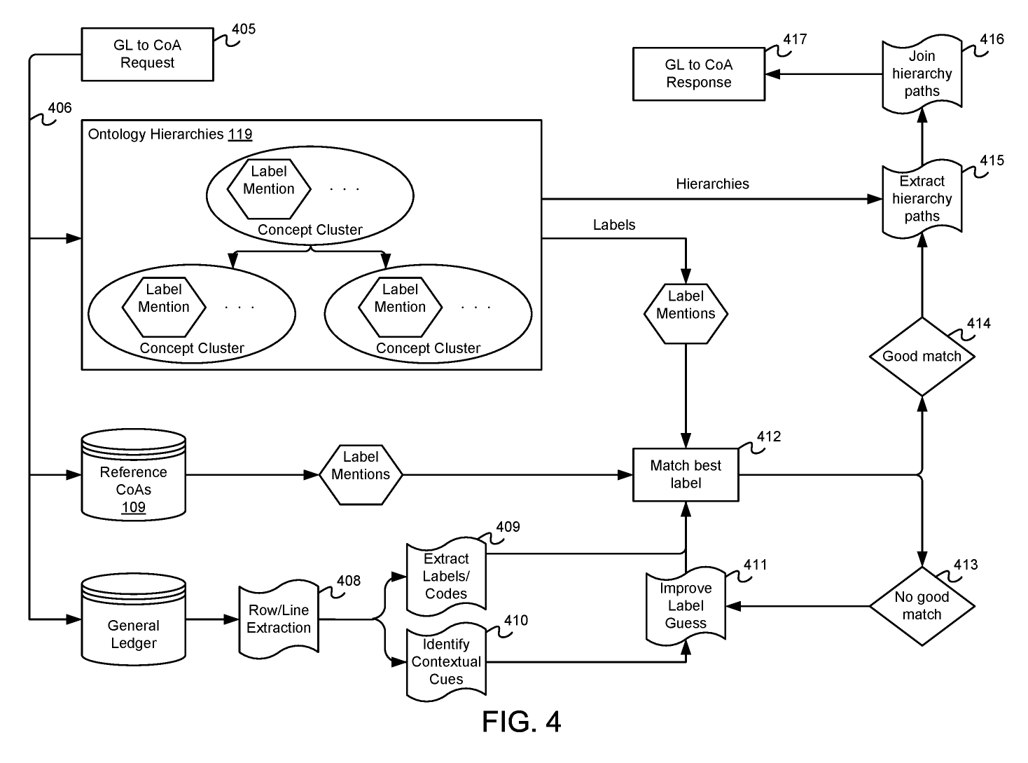

FIG. 4 illustrates an example data flow of generating a chart of accounts from a general ledger (GL), according to one embodiment. As described above, the flow is directed to identifying cues in the general ledger that indicate a given hierarchy to which a particular ledger entry refers. Such hierarchies include the ontology hierarchies 119, which the CoA generation tool 107 can augment with reference CoAs 109 (which include known CoAs previously evaluated by the ontology application 117 and other organizational entity CoAs).

In this example data flow, the extraction component 305 receives a request to generate a CoA from a general ledger (GL) (at 405). Illustratively, at 406, the evaluation component 315 may identify each entry of the general ledger relative to ontology hierarchies 119 and reference CoAs 109. To do so, the extraction component 305 (at 408) retrieves row and column data for each entry. Further the extraction component 305 (at 409) extracts labels and codes from the row and column data. Further the evaluation component 315 may identify contextual cues (e.g., neighboring rows/columns, account string description provided with the row, etc.) in the row and column data (at 410), and uses the contextual cues (at 411) to improve matching to a candidate label from either the ontology hierarchies or reference CoAs.

As stated, the evaluation component 310 determines candidates from the ontology hierarchies 119 and reference CoAs based on similarity measures to the GL entry labels and identified contextual cues. Doing so allows the evaluation component 310 to generate a probabilistic model. The model allows the matching component 315 to identify a candidate having a highest confidence score to a given entry label (at 412). The matching component 412 may determine whether the best match is a good match (at 414) that exceeds a specified threshold. If no good match presently exists (at 413), the evaluation component 310 may reinforce the probabilistic model using further identified contextual cues, such as neighboring rows (e.g. rows that have already been associated with a given hierarchy). Doing so allows the evaluation component 310 to improve matches to a given hierarchy (at 411).

Otherwise, for a match having a high confidence score that exceeds a threshold, the generation component 320 extracts hierarchy paths corresponding to the matched label (at 415). The generation component 320 may join the hierarchy paths to a current chart of accounts to be output to the user (at 416). After all of the hierarchy paths for the row entries have been extracted, the generation component 320 outputs the GL to CoA response (i.e., the resulting chart of accounts) to the user (at 417).

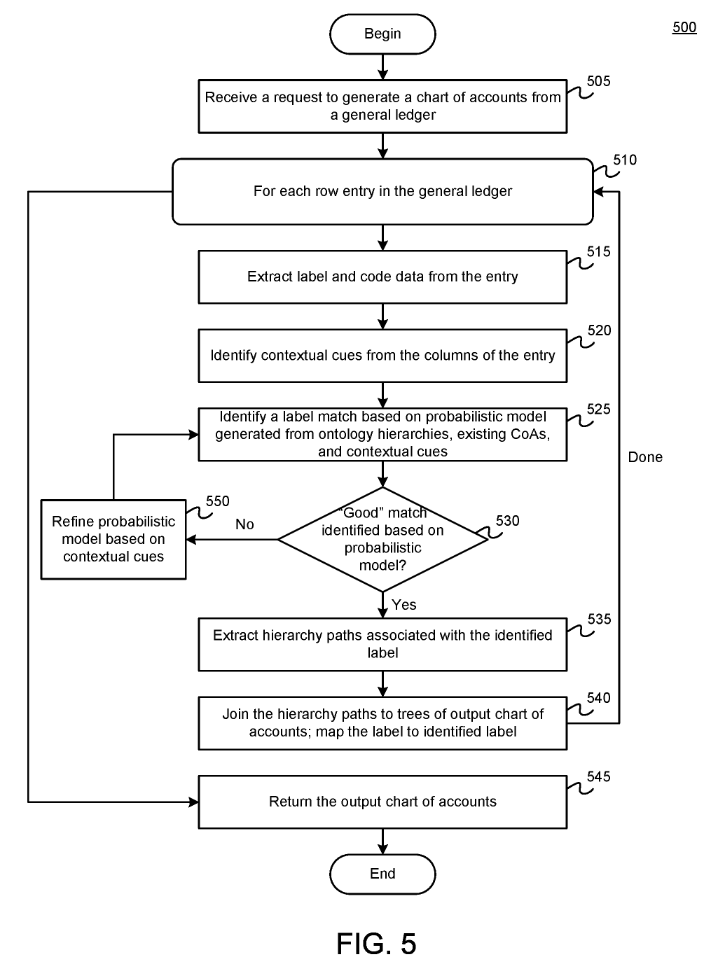

FIG. 5 illustrates a method 500 for generating an organized hierarchy from a set of data, according to one embodiment. As shown, the method 500 begins at step 505, where the extraction component 305 receives a request to generate a chart of accounts from a general ledger. The request may include the general ledger as input. The extraction component 305 may retrieve, from the general ledger, row entry and column data used to determine a chart of accounts hierarchy.

At step 510, the method 500 enters a loop for each row entry in the general ledger (from steps 515 to 540). At step 515, the extraction component 305 retrieves account string data (e.g., label and account code information) from the row entry. At step 520, the evaluation component 310 identifies contextual cues from the column data provided for the entry. As stated, contextual cues may include neighboring row data and description metadata for the account string. For example, if a neighboring row entry was previously evaluated to match to a given label at a hierarchical position in the resulting chart of accounts hierarchy, the label and matched position might indicate that the current row entry may be within or near that position in the hierarchy.

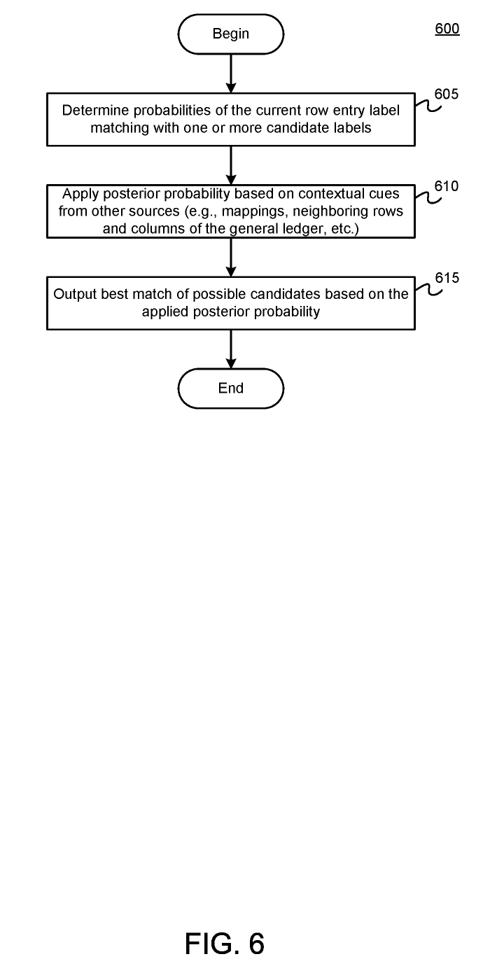

At step 525, the evaluation component 310 identifies a label corresponding to the label of the row entry based on the ontology hierarchies 119, the reference CoAs 109, and the contextual cues. This step is discussed in further detail relative to FIG. 6. Generally, the evaluation component 310 constructs a probabilistic model based on a union space of candidate labels identified in the ontology hierarchies 119 and reference CoAs 109. The evaluation component 310 may further augment the model using the identified contextual cues. The matching component 315 may use the probabilistic model to generate a confidence score for each candidate. Further, the matching component 315 may determine whether a highest scoring candidate label is a “good” match—for instance, the match exceeds a given threshold (at step 530). If not, then at step 550, the matching component 315 refines the probabilistic model based on additional contextual cues.

Otherwise, at step 535, the generation component 320 extracts hierarchy paths associated with the matching label from the ontology hierarchies 119. The hierarchy paths represent the place within the resulting chart of accounts to which the account string refers. At step 540, the generation components 320 joins the hierarchy paths to create trees for the output chart of accounts. The generation component 320 also maps the account string label to the identified matching label.

Once a hierarchy of all row entries of the general ledger is created, the generation component 320 returns the resulting chart of accounts in response to the request. As stated, a user may review the chart of accounts and make any modifications to the labels as needed.

FIG. 6 illustrates a method 600 for identifying a hierarchical label corresponding to a general ledger entry, according to one embodiment. In particular, method 600 further describes step 525 of method 500.

As shown, method 600 begins at step 605, where the evaluation component 310 determines probabilities of the current row entry label matching with one or more candidate labels of the ontology hierarchies 119 and reference CoAs 109. To do so, the evaluation component 310 may evaluate the label against every concept cluster in the ontological hierarchy 119 independently. Doing so results in an initial probability for a given label, which indicates that the concept cluster is the correct association.

At step 610, the evaluation component 310 applies a posterior probability formula using a probability distribution of label assignments in the ontological hierarchy 119 and identified contextual cues for the general ledger row entry. In one embodiment, the posterior probability formula may be represented as:

$$p ( θ \vert x ) = \frac{p ( x \vert θ ) p ( θ )}{p ( x )}$$

Evaluating the formula results in a remaining best match that is the argmax of the match distribution given the aforementioned context. At step 615, the matching component 315 outputs the best match and confidence score of the match based on the posterior probability formula.

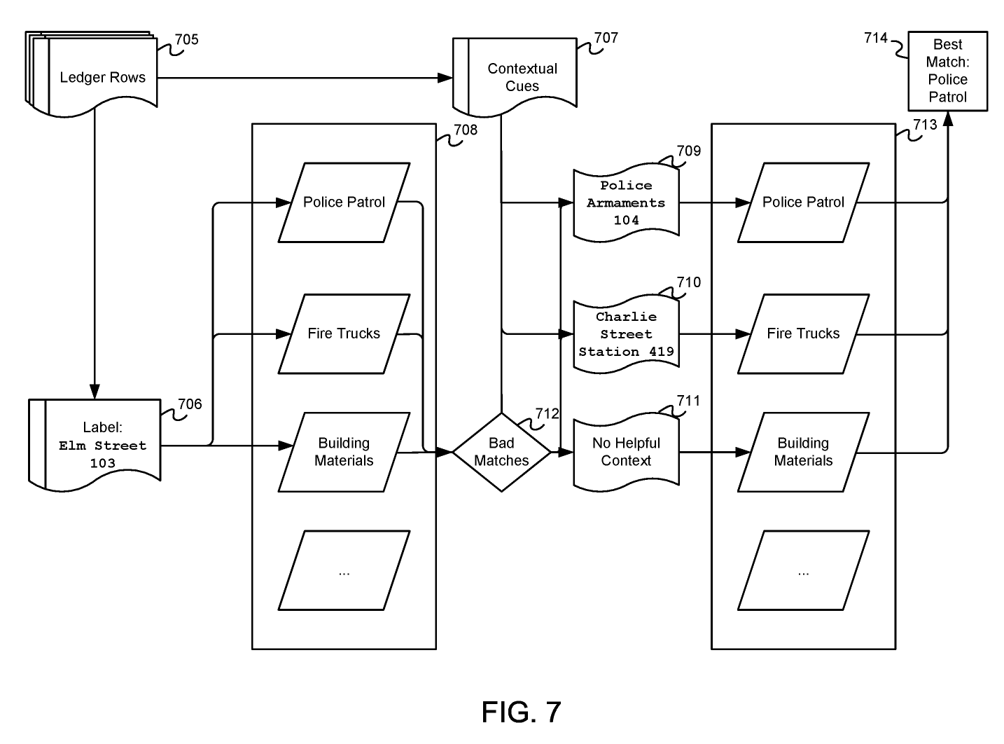

FIG. 7 illustrates an example evaluation of a ledger label and code segment against candidate labels, according to one embodiment. In particular, FIG. 7 depicts an example evaluation of a ledger label and a code segment 706 against candidate labels for the resulting chart of accounts. Illustratively, the example label and code segment 706 depicts a label “Elm Street” and code segment “103,” extracted from one of ledger rows 705.

The evaluation component 310 may identify an initial distribution 708 of candidates, which include “Police Patrol,” “Fire Trucks,” and “Building Materials,” among others. The initial distribution 708 may indicate that each candidate does not have a confidence score that indicates a good match (bad matches 712). The evaluation component 707 may further apply contextual cues 707 to the matches to further improve probabilities that the label 706 matches to a given candidate. As stated, the contextual cues 707 may include data from other mappings to the resulting chart of accounts, labels and code segments from neighboring rows, etc. The evaluation component 310 may apply the posterior probability formula based on the contextual cues 707.

In this example, the contextual cues 707 include label and code segments 709 and 710 (“Police Armaments 104” and “Charlie Street Station 419,” respectively) and an indicator 711 of “No Helpful Context.” The label and code segment 709 for Police Armaments 104 provides additional context suggesting that the label and code segment 706 matches to “Police Patrol” (as indicated by the one-way arrow to “Police Patrol” in a distribution 713). The label and code segment 710 provides additional context suggesting that the label and code segment 710 matches to “Fire Trucks,” as indicated by the one-way arrow. Further, the indicator 711 pointing to “Building Materials” suggests that the label and code segment 706 does not match to “Building Materials.”

After the evaluation component 310 applies the posterior probability formula to the distribution 713, the matching component selects “Police Patrol” from the distribution 713 as a best match based on the scored association generated from the formula.

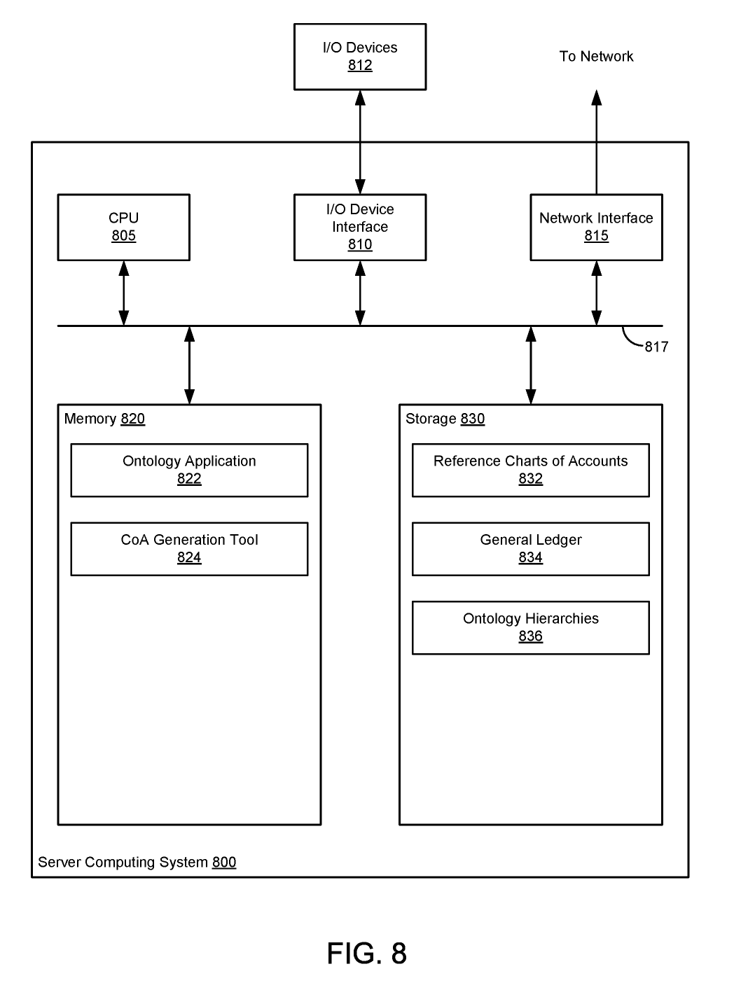

FIG. 8 illustrates an example server computing system 800 configured to generate an organized hierarchy from a set of data, according to one embodiment. As shown, the computing system 800 includes, without limitation, a central processing unit (CPU) 805, a network interface 815, a memory 820, and storage 830, each connected to a bus 817. The computing system 800 may also include an I/O device interface 810 connecting I/O devices 812 (e.g., keyboard, display and mouse devices) to the computing system 800. Further, in context of this disclosure, the computing elements shown in computing system 800 may correspond to a physical computing system (e.g., a system in a data center) or may be a virtual computing instance executing within a computing cloud.

The CPU 805 retrieves and executes programming instructions stored in the memory 820 as well as stores and retrieves application data residing in the storage 830. The interconnect 817 is used to transmit programming instructions and application data between the CPU 805, I/O devices interface 810, storage 830, network interface 815, and memory 820. Note, the CPU 805 is included to be representative of a single CPU, multiple CPUs, a single CPU having multiple processing cores, and the like. And the memory 820 is generally included to be representative of a random access memory. The storage 830 may be a disk drive storage device. Although shown as a single unit, the storage 630 may be a combination of fixed and/or removable storage devices, such as fixed disc drives, removable memory cards, or optical storage, network attached storage (NAS), or a storage area-network (SAN).

Illustratively, the memory 820 includes an ontology application 822 and a chart of accounts (CoA) generation tool 824, which both may collectively form a financial transparency application that includes a number of other software applications configured to process budgetary data belonging to local governments and presents the data to a user through graphs and other analytics. And the storage 830 includes one or more reference charts of accounts 832, a general ledger 834, and ontology hierarchies 836. The ontology application 822 generates ontology hierarchies 836 from external sources, e.g., charts of accounts from organizational entities and other reference charts of accounts 832. The ontology hierarchies 836 provide a normalized tree hierarchy of entity clusters, where each cluster is associated with one or more elements observed in the external sources.

The CoA generation tool 824 builds a chart of accounts from an input general ledger (e.g., general ledger 834). The CoA generation tool 824 can receive, as input, a request to generate a chart of accounts from an input general ledger (or multiple general ledgers). The CoA generation tool 824 can then, for each row entry label and code segment, identify candidate matches from a probabilistic model generated from sources such as reference charts of accounts 832 and ontology hierarchies 836. The CoA generation tool 824 may thereafter refine the probabilistic model using contextual cues identified from the general ledger 834 and assign the row entry label and code segment a corresponding hierarchy path. Doing so allows the CoA generation tool 824 to construct the resulting chart of accounts from the assigned hierarchy paths. The CoA generation tool 824 may then output the chart of accounts to a user.

In the preceding, reference is made to embodiments of the present disclosure. However, the present disclosure is not limited to specific described embodiments. Instead, any combination of the following features and elements, whether related to different embodiments or not, is contemplated to implement and practice the techniques disclosed herein. Furthermore, although embodiments of the present disclosure may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet. In context of the present disclosure, the financial transparency application may be hosted on a cloud server. For example, the financial transparency application may be provided to subscribing users as a Software-as-a-Service. Further, the ontology hierarchies may be generated on cloud servers. More specifically, the financial transparency application may retrieve online sources to generate the ontology hierarchies, and the chart of accounts generation tool may retrieve hierarchy path data from the ontology hierarchies via the cloud. Advantageously, as additional charts of accounts are processed (thereby increasing the size of the ontology hierarchies), capacity to accommodate the increase may be easily provisioned to the cloud servers.

Embodiments presented herein describe techniques for generating an ontological structure from a flat-dimensional data set using related data. Advantageously, the techniques use feature association to resolve disjointed hierarchy nodes to an existing and well-defined complete hierarchy. In addition, the techniques may include identifying contextual cues that allow unlikely matches for corresponding labels to be trimmed from a pool of candidate matches—thus improving classification. Further, the feature association disclosed in these embodiments evaluates discrete labels against a hierarchy of known labels.

While the foregoing is directed to embodiments of the present invention, other and further embodiments of the invention may be devised without departing from the basic scope thereof, and the scope thereof is determined by the claims that follow.

What is claimed is:

1. A method for generating an organized hierarchy from an input data set based on related data, the method comprising:
receiving a request to generate an organized hierarchy from a data set, wherein the data set includes a plurality of labels and contextual cues associated with each of the plurality of labels;
for each label:
identifying, based on a probabilistic model generated from a plurality of known ontological hierarchies, one or more candidate labels that are a potential match to the label, wherein each of the candidate labels is associated with a given hierarchy path, and
matching, based on the probabilistic model, the label to one of the candidate labels, and
assigning the label to the matched candidate label; and
joining the hierarchy paths associated with the assigned candidate labels with one another to build the organized hierarchy.

2. The method of claim 1, wherein the organized hierarchy is a chart of accounts and the data set is a general ledger.

3. The method of claim 2, further comprising:
returning the chart of accounts in response to the request.

4. The method of claim 2, wherein the probabilistic model is further generated from reference charts of accounts.

5. The method of claim 1, further comprising:
refining the probabilistic model based on the contextual cues associated with the label.

6. The method of claim 1, wherein the probabilistic model indicates, for each of the candidate labels, a likelihood that the label is a match for the candidate label.

7. The method of claim 1, further comprising, prior to assigning the label to the matched candidate label:
identifying the hierarchy path associated with the matched candidate label.

8. A non-transitory computer-readable storage medium storing instructions, which, when executed on a processor, performs an operation for generating an organized hierarchy from an input data set based on related data, the operation comprising:
receiving a request to generate an organized hierarchy from a data set, wherein the data set includes a plurality of labels and contextual cues associated with each of the plurality of labels;
for each label:
identifying, based on a probabilistic model generated from a plurality of known ontological hierarchies, one or more candidate labels that are a potential match to the label, wherein each of the candidate labels is associated with a given hierarchy path, and
matching, based on the probabilistic model, the label to one of the candidate labels, and
assigning the label to the matched candidate label; and
joining the hierarchy paths associated with the assigned candidate labels with one another to build the organized hierarchy.

9. The computer-readable storage medium of claim 8, wherein the organized hierarchy is a chart of accounts and the data set is a general ledger.

10. The computer-readable storage medium of claim 9, wherein the operation further comprises:
returning the chart of accounts in response to the request.

11. The computer-readable storage medium of claim 9, wherein the probabilistic model is further generated from reference charts of accounts.

12. The computer-readable storage medium of claim 8, wherein the operation further comprises:
refining the probabilistic model based on the contextual cues associated with the label.

13. The computer-readable storage medium of claim 8, wherein the probabilistic model indicates, for each of the candidate labels, a likelihood that the label is a match for the candidate label.

14. The computer-readable storage medium of claim 8, wherein the operation further comprises, prior to assigning the label to the matched candidate label:
identifying the hierarchy path associated with the matched candidate label.

15. A system, comprising:
a processor and
a memory hosting an application, which, when executed on the processor, performs an operation for generating an organized hierarchy from an input data set based on related data, the operation comprising:
receiving a request to generate an organized hierarchy from a data set, wherein the data set includes a plurality of labels and contextual cues associated with each of the plurality of labels,
for each label:
identifying, based on a probabilistic model generated from a plurality of known ontological hierarchies, one or more candidate labels that are a potential match to the label, wherein each of the candidate labels is associated with a given hierarchy path, and
matching, based on the probabilistic model, the label to one of the candidate labels, and
assigning the label to the matched candidate label, and
joining the hierarchy paths associated with the assigned candidate labels with one another to build the organized hierarchy.

16. The system of claim 15, wherein the organized hierarchy is a chart of accounts and the data set is a general ledger.

17. The system of claim 16, wherein the probabilistic model is further generated from reference charts of accounts.

18. The system of claim 15, wherein the operation further comprises:
refining the probabilistic model based on the contextual cues associated with the label.

19. The system of claim 15, wherein the probabilistic model indicates, for each of the candidate labels, a likelihood that the label is a match for the candidate label.

20. The system of claim 15, wherein the operation further comprises, prior to assigning the label to the matched candidate label:
identifying the hierarchy path associated with the matched candidate label.
